(19) United States
(12) Patent Application Publication
(10) Pub. No.: US 2004/0052403 A1
(43) Pub. Date: Mar. 18, 2004

(54) High volume mobile identity verification system and method

(76) Inventor: Robert C. Houvener, Nashua, NH (US)

Correspondence Address: SCOTT C. RAND, ESQ., MCLANE, GRAF, RAULERSON & MIDDLETON, PA, 900 ELM STREET, P.O. BOX 326, MANCHESTER, NH, 03105-0326, US

(21) Appl. No.: 10/058,198

(22) Filed: Jan. 25, 2002

(51) Int. Cl. G06K 9/00

(52) U.S. Cl. 382/115

(57) ABSTRACT

A security identification system is disclosed for providing information regarding subjects to be identified. The system includes a biometric data input unit, a biometric analysis unit, an expert analysis unit, and a security clearance output unit. The biometric data input unit is for receiving biometric data regarding a subject. The biometric analysis unit is for analyzing the biometric data and comparing it against known biometric data in a database. The biometric analysis unit is also for providing match data that is indicative of whether a match exists and whether the match is above a certain correlation threshold. The expert analysis unit is for providing the biometric data to an analyst workstation if the match data is below a certain correlation threshold. The security clearance output unit is coupled to the biometric analysis unit and to the expert analysis unit for providing an indication of whether the subject is cleared.

The present invention relates to the field of security identification systems, and relates in particular to systems and methods for verifying the identity of persons in high volume screening applications.

### BACKGROUND OF THE INVENTION

Conventional systems for verifying the identity of persons typically involve either the use of highly skilled screening personnel at a large number of screening points, or involve the use of biometric analysis systems. The use of a large number of highly skilled screening personnel that compare photographic identification documents or cards with the face of the person whose identification is being verified is difficult and expensive to achieve since each screener must be highly skilled in complex personal identification techniques. The use of poorly trained screening personnel presents a dangerous false sense of security. Moreover, even with highly skilled screeners, inconsistencies between procedures used by different screeners may present further difficulties.

The use of biometric analyses standardizes and automates much of the process, but applications using biometric analyses suffer from shortcomings as well. For example, many biometric analysis systems require some human interpretation of the data to be certain in a high percentage of cases, and this interpretation may vary. Moreover, the process of obtaining reliable and consistent biometric information from a large number of persons to be identified remains difficult due to biometric data capturing concerns, particularly with non-contact biometric data capturing. Certain conventional non-contact biometric data capturing systems use video cameras to capture the faces of people in a subject area, or employ non-contact sensors to capture characteristics of parts of a person's body. Such systems, however, remain inconsistent and insufficiently reliable, at least in part due to variations in how the subject is presented to the video camera or sensor. For facial recognition, poor lighting and poor pose angles present significant difficulties. Difficulties are also presented by having a moving subject with a fixed camera view area, particularly if the subject's face occupies a small portion of a large and highly varying view area. Other non-contact biometric techniques include iris scanning, which requires that each subject to walk up to a capture device, align themselves correctly and have their iris scanned and verified. Contact based biometric systems, such as finger print readers, are generally considered to be less safe from a health standpoint due to having a large number of persons touch the same device over a long period of time.

For example, U.S. Pat. No. 6,119,096 discloses a system and method for automated aircraft boarding that employs iris recognition. The system, however, requires that each passenger be initially enrolled and scanned into the system. U.S. Pat. No. 6,018,739 discloses a distributed biometric personal identification system that uses fingerprint and photographic data to identify individuals. The system is disclosed to capture biometric data at workstations and to send it to a centralized server via a wide area telecommunications network for automated processing. Similarly, U.S. Pat. No. 6,317,544 discloses a distributed mobile biometric identification system with a centralized server and mobile workstations that uses fingerprint and photographic data to identify individuals. The system is disclosed to capture biometric data at workstations and to send it to a centralized server via a wireless network for automated processing. Each of these systems, however, may produce false positive identifications (which may overwhelm a review system) or miss certain identifications due to uncertainties in biometric data capture and/or analysis as discussed above.

There is a need, therefore, for an efficient and economical system and method that provides improved personal identity verification for a large number of persons in a high volume environment.

### SUMMARY OF THE INVENTION

The invention provides a security identification system and method for providing information regarding subjects to be identified. The system includes a biometric data input unit, a biometric analysis unit, an expert analysis unit, and a security clearance output unit. The biometric data input unit is for receiving biometric data regarding a subject. The biometric analysis unit is for analyzing the biometric data and comparing it against known biometric data in a database. The biometric analysis unit is also for providing match data that is indicative of whether a match exists and whether the match is above a certain correlation threshold. The expert analysis unit is for providing the biometric data to an analyst workstation if the match data is below a certain correlation threshold. The security clearance output unit is coupled to the biometric analysis unit and to the expert analysis unit for providing an indication of whether the subject is cleared.

### BRIEF DESCRIPTION OF THE DRAWINGS

The following description may be further understood with reference to the accompanying drawing in which:

FIG. 1 shows an illustrative view of a screener using a system in accordance with an embodiment of the invention to screen a subject;

FIG. 2 shows an illustrative enlarged view of the screener of FIG. 1 wearing a data collection unit in accordance with the system shown in FIG. 1;

FIG. 3 shows an illustrative view of a screen display as seen by a screener in accordance with an embodiment of the invention;

FIG. 4 shows an illustrative flowchart of the operation of a system in accordance with an embodiment of the invention;

FIG. 5 shows an illustrative diagrammatic view of a system in accordance with an embodiment of the invention;

FIG. 6 shows an illustrative view of a packet of information that is communicated from a screener to a central facility in accordance with an embodiment of the invention; and

FIG. 7 shows an illustrative view of a screen display as seen by an expert analyst in accordance with an embodiment of the invention.

The drawings are shown for illustrative purposes.

### DETAILED DESCRIPTION OF THE INVENTION

The present invention provides for systems and methods for optimally gathering biometric data and documentation data regarding individuals whose identity is to be verified in high volume screening applications. In an embodiment, the method involves the use of face to face human interaction to set up and execute scripted scenarios for operators (screeners) to follow, ensures that optimal quality data is captured in a highly consistent manner. The collection method is driven by the voice of the screener as part of the normal conversation with the person being screened. The screener is queued by an interactive teleprompter on a miniature screen display. In the case of ambiguous biometric results, the system involves a live identification expert with access to auxiliary data to assist the field-based screener via live text, audio and video. The method provides significant improvement in biometric performance and improves screening efficiency. The system also provides interactive training of screening personnel in an embodiment based on their on-going performance.

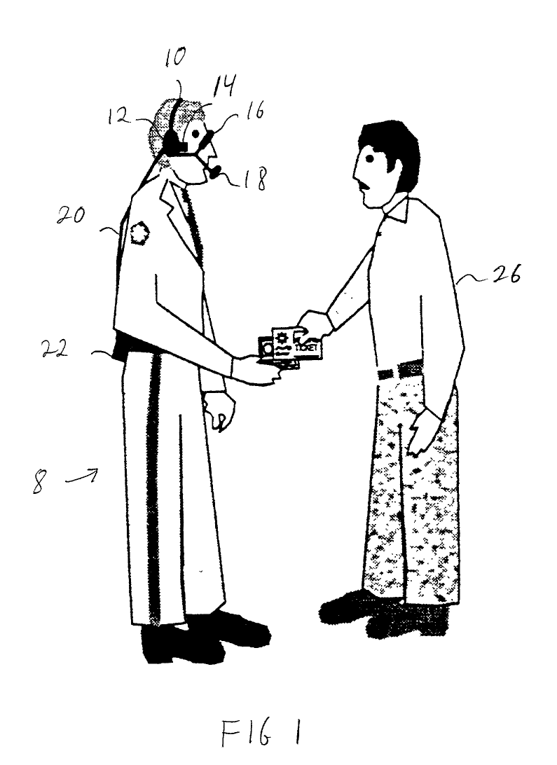

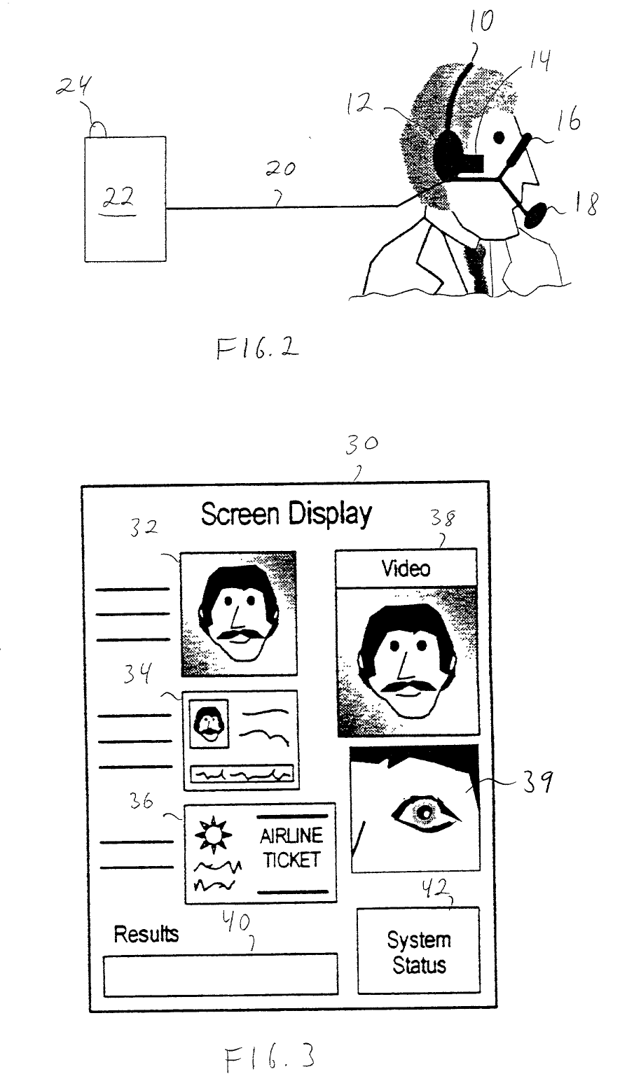

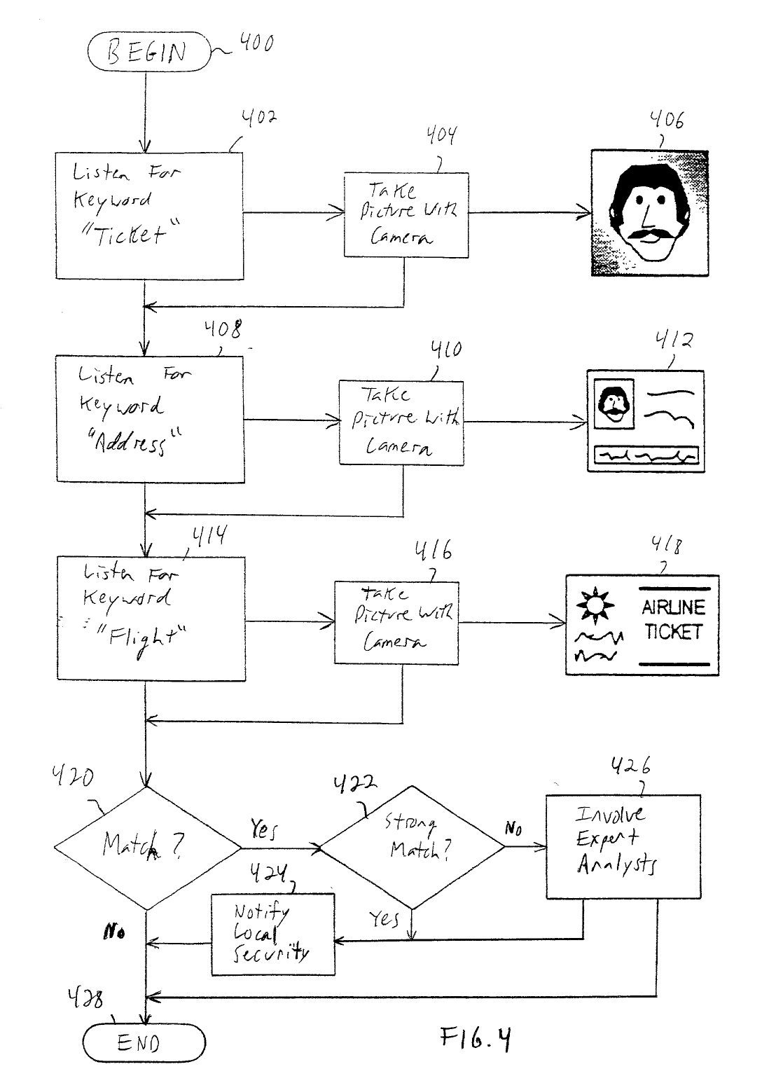

As shown in FIG. 1, in accordance with an embodiment of the invention, a screener 8 may wear a specialized data collection and display device 10 that includes an earphone 12, a camera 14, a micro display 16, and a microphone 18. The camera 14 is a miniature high resolution color camera. The micro display 16 is a miniature high resolution color display that is viewable only by the screener, such as those sold by MicroOpical Corporation of Westwood, Mass. The display may project an image into space in front of the screener's face (again viewable only by the screener). As also shown in FIG. 2, the device 10 is connected via a cable 20 to a small computer 22, which in turn communicates via an antenna 24 and a high speed wireless connection to a central analysis facility. The computer 22 may be worn by a screener on a waist belt out of view of the person being screened 26. In further embodiments, the devices 10 may be made even smaller, with each communication device fitting on a single pair of eyeglasses so as to fully minimize the impact on the subject 26 and permit natural interaction between the screener 8 and subject 26. Each device 10 is personalized at the time of use to a particular authorized screener. All communications with the central analysis facility are encrypted. The device application software includes two way voice, text (from the central facility) and two way video and still image capture/display, as well as local biometric data, compression, control and communication capabilities. The device 10 is completely driven by the voice of the screener for all real-time functions via keyword spotting that is tied to the main screening script as discussed in more detail below. The miniature display 16 may provide a significant amount of information in the form of a screen display 30 as shown in FIG. 3, including a photograph 32 of the subject 26, a photograph of the subject's identification card (ID) 34, a photograph of the subject's airline ticket 36, a streaming video image 38, and an image of an eye 39 for, e.g., iris scanning or retinal imaging. In certain embodiments, the camera 14 may have sufficient resolution to locate the one or both eyes in the image of the subject's face, and increase the scale of the eye to fill the viewing image to create the image 39 for processing. The display may also provide a results field 40 and a system status field 42, and the may further include text accompanying any of the various photographs or images as shown, as well as text generated from remote locations.

All devices 10 are connected in real time to one or more analysis facilities via standard high-speed commercial telecommunications providers. The analysis facility includes strong authentication and firewalls for incoming and outgoing communications. It contains a very high speed local area network (LAN)/storage area network (SAN) system, connecting database and analysis servers to devices 10 and to human analysts and quality control personnel. The analysis servers include generalized correlation engines, biometric correlation engines, as well as other automated support for screener based devices, in addition to local analysts supporting screeners in the field. Also at these facilities are automated on-line training/screening performance metrics servers. The secure facilities may be run under United States Department of Defense security standards and may be staffed with fully security cleared operators, particularly at the expert analysts workstations. These workstations are provided with real time connection to the screening process, both locally and out to the screeners via voice, image, video and text communication. The analysis facility has local copies of known threat data, as well as secure connectivity to appropriate governmental agencies. The system combines real time access to experts with the least traveler inconvenience or impact. The system may be used, for example at airports during check-in, gate-entry-screening, boarding, or baggage claim. In further embodiments, the system may be used in a wide variety of environments where the accurate and rapid identification of individuals is required such as any secure entry or access facility.

With reference to FIG. 4, the system begins (step 400) when a subject to be screened walks up to a screener at, for example, an airline ticket counter at an airport or an airline gate screening security station. In various embodiments, the screener may be required to log in and verify their own identity via the biometric analysis system. As shown in FIG. 4, during operation the screener follows a script and looks directly at the subject and asks to see the subject's ticket. When the system hears the screener say the word “ticket” (step 402) it takes a picture of whatever the screener is looking at at that moment. The image 406 of the subject that is taken by the camera will be a close up picture in full view of the subject's face and/or eye from a front-on direction. The screener should be trained to not say the word “ticket” until the subject is looking at the screener. In various embodiments, the system may permit the picture to be retaken if the subject fails to look toward the screener by again stating the word “ticket” or by recognizing some other pre-arranged command, such as “look at me, please” if necessary. The image 406 is recorded by the computer 22. In further embodiments, the system may also automatically request that the screener re-take a picture, for example, if the biometric processing results in an ambiguity.

The screener then asks for some photo-identification, and while looking at the photo-identification the screener asks whether the address on the photo-id is the current address. The system hears the word “address” (step 408) and takes a photograph (step 410) of the photo-id that the screener is looking at. The photograph of the identification card 412 is also recorded by the computer 22. The screener then looks at the ticket and reads the flight information out loud (e.g., “I see that you are on Flight 100 to Washington D.C.”). When the system hears the word “flight” (step 414) it takes another picture (step 416), this time of the ticket 418, which is recorded by the computer 22. Each of the pictures 406, 412 and 418 are recorded in seconds, without interrupting the normal flow of passenger interaction. The pictures taken by the camera 14 are shown on the display as illustrated in FIG. 3 at 32, 34 and 36 respectively, and are processed for transmission to the central facility. Biometric analysis may be performed by each computer 22 or preferably sent to the central facility for biometric analysis as well.

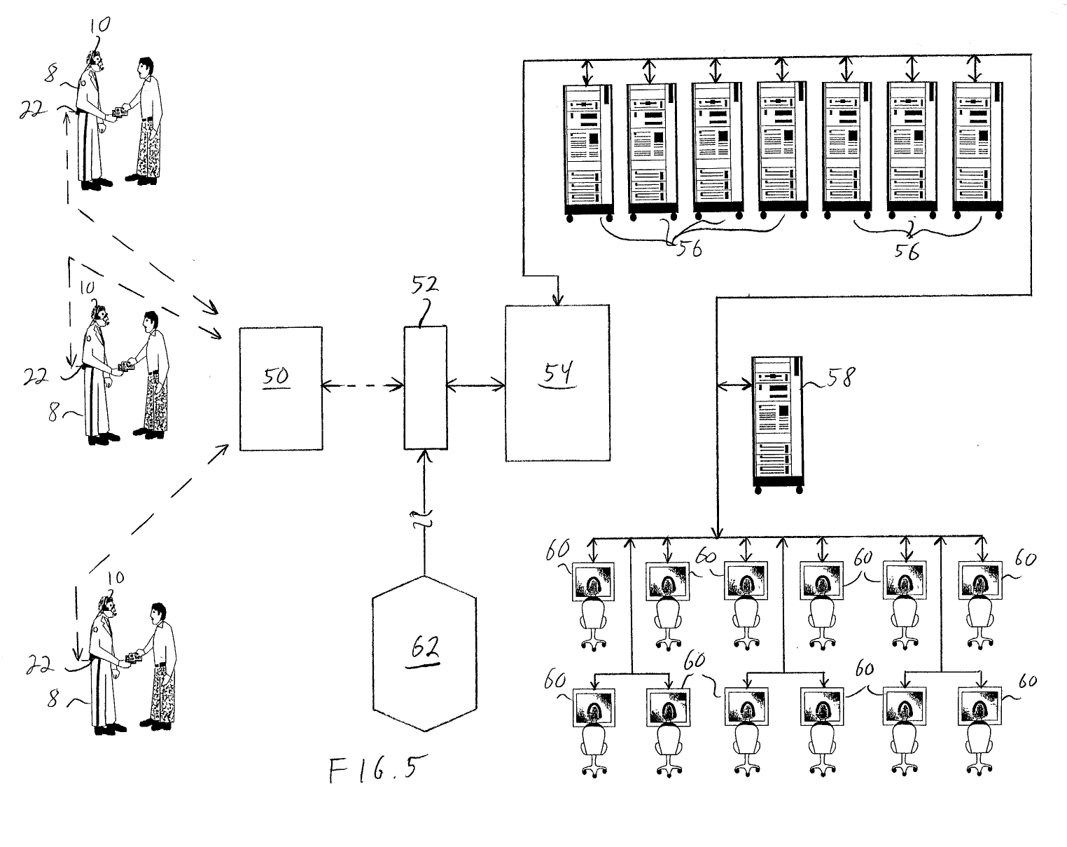

As shown in FIG. 5, each screener 8 has a data collection device 10 that is attached to a computer 22 that communicates via wireless communication to a central facility (optionally via a local wireless transmitter/receiver station 50). The central facility includes a firewall 52, a central wireless transmitter/receiver station 54, and a number of high speed LAN/SAN data storage and analysis processors. The central facility may also include an interactive and automated on-line screener training/performance metric system 58 that monitors the performance of each screener. The analysis processors 56 are also coupled to a bank of analysts work stations 60 for providing real time expert analysis support for the screeners via two way communication. The analysts stationed at the work stations 60 provide backup analysis in the event that the biometrics analysis is not fully satisfactory, and provide question and answer support/training for the screeners. The system may also include access to information from a Federal information link 62 such as to the Federal Bureau of Investigations.

While the ticket and photo-id are being captured, the real-time analysis system at the central facility runs the picture 406 of the subject's face, or a mathematical representation of the face that has been extracted from the picture at either the screener or central site, against the known database of high-risk individuals. If there is no match (step 420) then a message is sent to the screener's device, and the screener receives an indication in field 40 of FIG. 3 that the subject is cleared and free to go. Typical biometric analysis systems employ a variety of test characteristics that together provide a numerical number, e.g., a match of x out of y characteristics. A match is typically defined as a range (m−y) such that numbers in the range (m<x<y) indicate a match. A match is strong if the number x is close to y, and weak if the number x is close to the threshold m.

Referring again to FIG. 4, if there is a match, the system determines whether or not the match is strong or weak (step 422). If the match is strong (step 422), then the system prompts the screener to not let the subject pass and to contact security immediately (step 424) for further questioning or retention. In certain embodiments, the system may itself contact security immediately to assist the screener. If there is a match at step 420, but the match is weak (step 422), then the system automatically involves one or more experts (step 426) that are stationed at work stations 60 to assist in the analysis. The experts review the images and data in real time, and contact with screener with instructions to either clear the individual or to contact security.

The system then ends (step 428) and begins anew with the next subject to be screened. Even if the expert analysts are involved, the screening process should require only seconds to fully execute. The system may also automatically involve one or more experts if the individual with whom a match appears to exist is a known high risk individual regardless of whether the match is strong or weak.

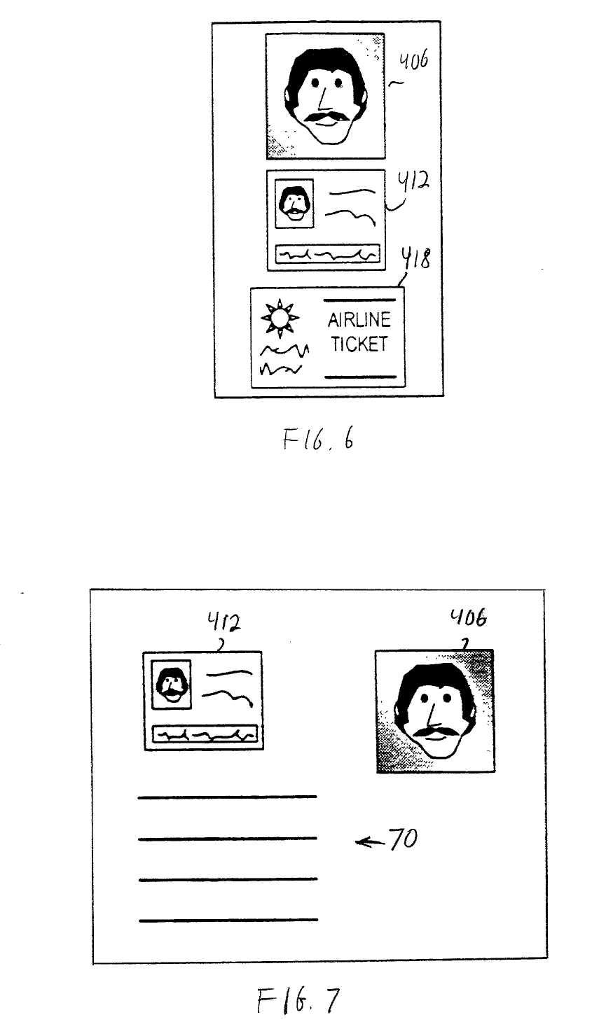

The system is not required to utilize any single biometric characteristic such as facial recognition, and may be modified to capture and review other biometric information such as voice prints and iris scanning. In any event, the benefits of both biometric analyses and the use of expert analysts in real time significantly improves results for minimal costs. As shown in FIG. 6, the packet of information that is sent to the central facility for any particular subject includes the biometric information as well as copies of the pictures taken of the subject's face 406, photo-id 412 and photograph of the ticket 418. As shown in FIG. 7, each expert analyst station may include the above as well as any pertinent classified information 70 that is available only to the expert analysts.

The present invention provides high quality data capture and screening by leveraging the interaction between screening personnel and people being screened. Biometric data collection devices that are worn by the screener rely on the proximity and voice interaction between the screener and subject to obtain very reliable biometric data. The collection devices also communicate with a central control system for full analysis and reporting of the biometric data.

The visual prompting of the screener, in synchronization with the collection system, yields a systematic, uniform, natural, efficient and optimal data collection process. This increases the likelihood of detecting a known high-risk individual, and minimizes the number of false positive identifications. The system also reduces the required level of skill of the screeners that are in contact with the persons to be identified. Duplicate screeners, in fact, may even be employed at different stations in an airport, such as check-in, gate-entry, boarding and baggage claim. Further, the system may provide a safeguard that ensures that each passenger boarded a plane, that their luggage is on the plane, and that the luggage is later claimed by the correct person.

The real time automated switching of the screening from a totally automated biometric decision process, to an expert-in-the-loop process, allows any false match problems to be handled in a efficient manner. By utilizing experts, false matches may be cleared in seconds and

By capturing the biometric data and identification and travel documents at the same time, a complete data set is efficiently and economically captured for each individual. By analyzing these data sets on a per screener basis, it is possible to discern areas of each individual screener's performance that need improvement. The system permits direct communication between the screeners and the experts. By training screeners using systems of the invention, greater efficiency may be achieved in both the screening and training of screeners.

Those skilled in the art will appreciate that numerous modifications and variations may be made to the above disclosed embodiments without departing from the spirit and scope of the invention.

What is claimed is:

1. A security identification system for providing information regarding subjects to be identified, said system comprising:
biometric data input means for receiving biometric data regarding a subject;
biometric analysis means for analyzing said biometric data and comparing it against known biometric data in a database, and for providing match data that is indicative of whether a match exists and whether the match is above a certain correlation threshold;
expert analysis means for automatically providing said biometric data to an analyst workstation if the match data is below a certain correlation threshold; and
security clearance output means coupled to said biometric analysis means and to said expert analysis means for providing an indication of whether the subject is cleared.

2. The security identification system as claimed in claim 1, wherein said biometric data input means includes a miniature camera.

3. The security identification system as claimed in claim 1, wherein said biometric data input means includes a micro display that is viewable only by a screener that is using the biometric data input means.

4. The security identification system as claimed in claim 1, wherein said biometric data input means includes a microphone.

5. The security identification system as claimed in claim 1, wherein said biometric data input means includes an earphone, a microphone, a miniature camera and a micro display.

6. The security identification system as claimed in claim 1, wherein said biometric data input means includes a computer processor that is coupled to a camera and a microphone and said camera is programmed to take a picture responsive to information received by said microphone during normal conversation by a screener.

7. A personal identification system for providing information regarding subjects to be identified, said system comprising:
a headset that may be worn by a screener, said headset including an earphone, a camera, a micro display, and a microphone; and
a headset processor coupled to said headset for processing image data received by said camera and for transmitting processed image data to a central facility, said central facility including:
a storage medium including data regarding known high-risk individuals;
an analysis processor for comparing said processed image data with said data regarding known high-risk individuals and for producing match data indicative of the level of match of said processed image data with said data regarding known high-risk individuals; and
an expert analyst workstation for automatically receiving said processed image data if said match data indicates that a match is a weak match.

8. The security identification system as claimed in claim 7, wherein said headset includes a micro display.

9. The security identification system as claimed in claim 7, wherein said headset includes a miniature camera.

10. The security identification system as claimed in claim 7, wherein said system further provides training and performance feedback to a screener.

11. The security identification system as claimed in claim 10, wherein said performance feedback to a screener is automatically provided responsive to performance data that is automatically generated by said system for each screener.

12. A biometric data acquisition system for use in a security identification system, said data acquisition system comprising a unit that may be worn by a screener, said unit including a miniature camera that is configured to take a picture responsive to the sound of the screener saying a certain trigger word during normal conversation by the screener.

13. The biometric data acquisition system as claimed in claim 12, wherein said picture includes image data of a person's face from which biometric data may be extracted.

14. The biometric data acquisition system as claimed in claim 12, wherein said picture includes image data of an iris of a person's eye from which biometric data may be extracted.

15. A method of verifying the identity of a person and checking whether the person is a high-risk individual, said method comprising the steps of:
stating a keyword while looking at the subject to be identified;
taking a picture responsive to the keyword of the subject; and
forwarding data representative of the picture of the subject to a central facility that includes data regarding known high-risk individuals in a central storage medium;
analyzing said data representative of the picture at the central facility.

16. The method as claimed in claim 15, wherein said method further comprises the steps of determining whether a match exists between said data representative of the picture and any of the data regarding known high-risk individuals, and generating match data that is indicative of whether a match exists and whether the match is strong or weak.

17. The method as claimed in claim 16, wherein said method further comprises the step of forwarding said data representative of the picture to an expert analyst at an expert analyst's workstation.

18. The method as claimed in claim 17, wherein said step of forwarding said data representative of the picture to an expert analyst at an expert analyst's workstation is responsive to said match data.

19. The method as claimed in claim 17, wherein said step of forwarding said data representative of the picture to an expert analyst at an expert analyst's workstation is responsive to said data regarding known high-risk individuals.
